(19) United States
(12) Patent Application Publication
(10) Pub. No.: US 2025/0052275 A1
(43) Pub. Date: Feb. 13, 2025

(54) JOINT ASSEMBLY

(71) Applicants: CCTY USA BEARING COMPANY, Lake Zurich, IL (US); CCTY BEARING COMPANY, Zhenjiang (CN)

(72) Inventors: Corey M. HELGESON, Lake Zurich, IL (US); John J. SWEETWOOD, Lake Zurich, IL (US); Da Li WANG, Lake Zurich, IL (US)

(21) Appl. No.: 18/640,523

(22) Filed: Apr. 19, 2024

Related U.S. Application Data
(60) Provisional application No. 63/531,415, filed on Aug. 8, 2023.

(51) Int. Cl. F16C 11/06

(52) U.S. Cl. CPC F16C 11/0614; F16C 11/0685

(57) ABSTRACT

A joint assembly includes a housing having a concave inner cup. The concave inner cup includes an inner surface having one or more angled grooves extending around at least a portion of a circumference of the inner surface. A liner can be molded into the inner cup. The liner fills the one or more angled grooves such that the liner is mechanically secured to the inner surface of the inner cup. A corresponding cap can also include similar angled grooves and liner.

### CROSS-REFERENCE TO RELATED APPLICATIONS

This application claims priority to and the benefit of U.S. Provisional Application No. 63/531,415, filed on Aug. 8, 2023, the entirety of which is incorporated herein by reference.

### TECHNICAL FIELD

In general, the present invention relates to an apparatus for forming a mechanical joint.

### BACKGROUND OF THE INVENTION

Many vehicles include one or more tie rods and/or ball joints as part of a steering mechanism and/or suspension. Such components can include one or more joints that undergo a variety of forces. These forces can include linear forces in one or more directions as well as rotational forces that can create a rotational movement of components as well as a rocking movement of the components.

### SUMMARY OF THE INVENTION

In accordance with an embodiment of the present invention, a joint assembly includes a housing having a concave inner cup. The concave inner cup includes an inner surface having one or more angled grooves extending around at least a portion of a circumference of the inner surface. A liner can be molded into the inner cup. The liner fills the one or more angled grooves such that the liner is mechanically secured to the inner surface of the inner cup. A corresponding cap can also include similar angled grooves and liner.

In accordance with an embodiment of the present invention, a method of manufacturing a joint assembly includes providing a housing having a concave inner cup, wherein the concave inner cup includes an inner surface having one or more grooves extending around at least a portion of a circumference of the inner surface; injecting or molding a liner material into the inner cup such that the liner material enters and fills into the one or more grooves; and curing the liner material to form a liner that is incorporated into the one or more grooves and mechanically secured to the inner cup.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of an exemplary tie rod assembly;

FIG. 2A is a front view of an exemplary tie rod end housing;

FIG. 2B is a cross-sectional view of an exemplary housing;

FIG. 2C is a cross-sectional view of an exemplary inner tie rod housing;

FIG. 3 is a front view of an exemplary housing liner;

FIG. 4A is a front view of an exemplary cap;

FIG. 4B is a cross-sectional view of an exemplary cap;

FIG. 4C is a cross-sectional view of an exemplary inner tie rod cap;

FIG. 5 is a front view of an exemplary cap liner;

FIG. 6 is a perspective view of an exemplary ball joint assembly;

FIG. 7A is a perspective view of an exemplary ball joint housing;

FIG. 7B is a cross-sectional view of an exemplary housing;

FIG. 8 is a perspective view of an exemplary housing liner;

FIG. 9A is a perspective view of an exemplary cap;

FIG. 9B is a cross-sectional view of an exemplary cap;

FIG. 10 is a perspective view of an exemplary cap liner;

FIG. 11A is a cross-sectional view of an exemplary tie rod end housing having an exemplary housing liner;

FIG. 11B is a top view of an exemplary tie rod end housing having an exemplary housing liner;

FIG. 12A is a cross-sectional view of an exemplary cap having an exemplary cap liner;

FIG. 12B is a top view of an exemplary cap having an exemplary cap liner;

FIG. 13A is a cross-sectional view of an exemplary ball joint housing having an exemplary housing liner;

FIG. 13B is a top view of an exemplary ball joint housing having an exemplary housing liner;

FIG. 14A is a cross-sectional view of an exemplary cap having an exemplary cap liner; and

FIG. 14B is a top view of an exemplary cap having an exemplary cap liner.

### DETAILED DESCRIPTION OF THE INVENTION

Embodiments of the invention relate to mechanical joint assembly. The mechanical joint assembly can be, for example, part of a tie rod or a ball joint. An embodiment of the joint assembly includes a housing having a concave inner cup. The concave inner cup includes an inner surface having one or more angled grooves extending around at least a portion of a circumference of the inner surface. A liner can be molded into the inner cup. The liner fills the one or more angled grooves such that the liner is mechanically secured to the inner surface of the inner cup. A corresponding cap can also include similar angled grooves and liner.

The best mode for carrying out the invention will now be described for the purposes of illustrating the best mode known to the applicant at the time of the filing of this patent application. The examples and figures are illustrative only and not meant to limit the invention, which is measured by the scope and spirit of the claims.

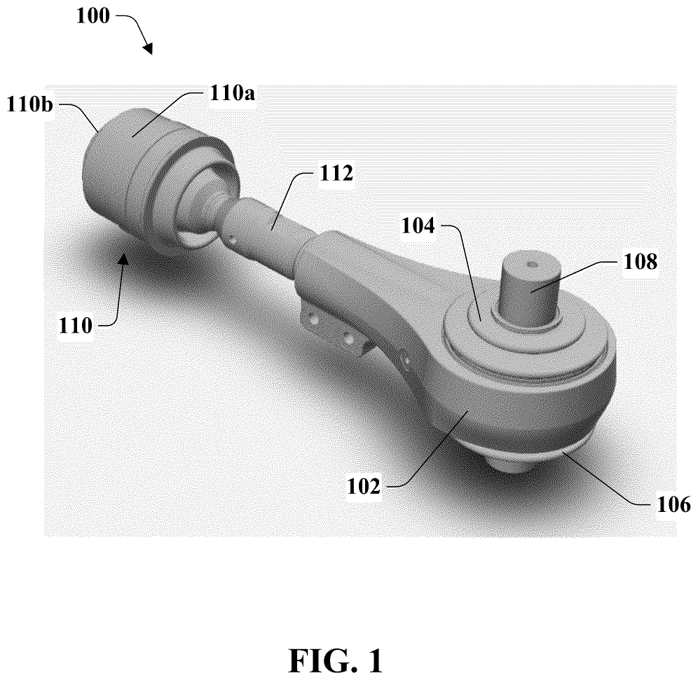

Referring now to the drawings, wherein the drawings are for the purpose of illustrating an exemplary embodiment of the invention only and not for the purpose of limiting same, FIG. 1 illustrates an example of a tie rod assembly 100. The tie rod assembly 100 can include a housing 102 on the tie rod end. The housing 102 can be coupled at a first end to a first end seal 104 and at a second end to a second end seal 106. A first ball stud 108 can include a ball (not shown in FIG. 1) nested within the housing 102, a first shaft extending from one end of the ball and through an aperture in the first end seal 104, and a second shaft extending from an opposite end of the ball and through an aperture in the second end seal 106. The first ball stud 108 can undergo rotational movement and also a rocking movement in any direction with respect to the housing 102 while coupled with the housing 102.

The tie rod assembly 100 can further include an inner tie rod 110 coupled to the tie rod end housing 102 with a second ball stud 112. In this manner, the inner tie rod 110 can undergo rotational movement and also a rocking movement in any direction with respect to the housing 102 while coupled with the housing. It should be appreciated that the inner tie rod 110 can include a housing 110a and a cap 110b. One exemplary application of the tie rod assembly 100 is to connect a vehicle's steering gear and/or hydraulic cylinder to the steering knuckle. The tie rod assembly 100 can be incorporated into any vehicle, including, but not limited to, cars, trucks, all-terrain vehicles, construction equipment, tractors, combines, golf carts, among others.

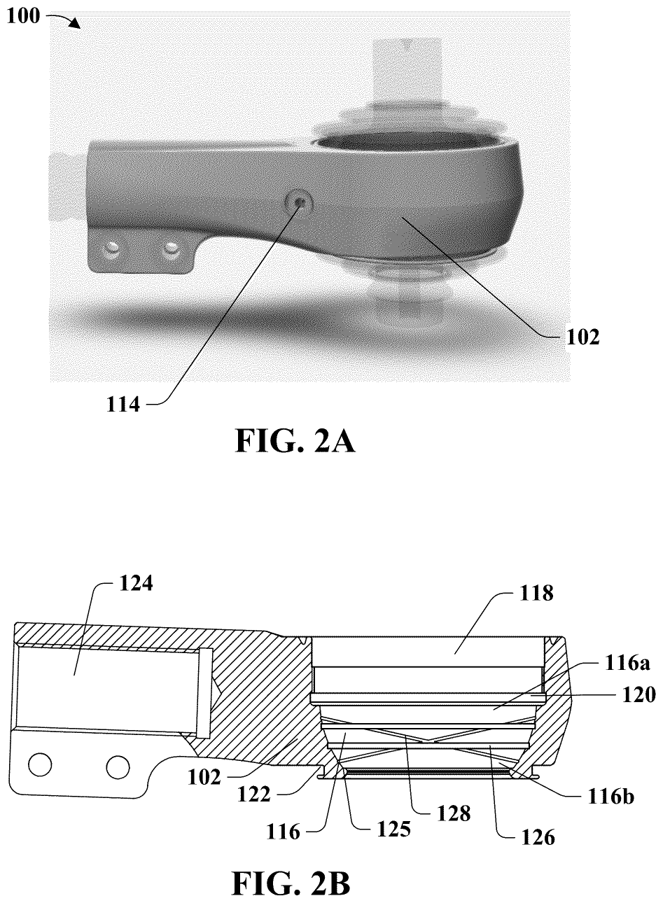

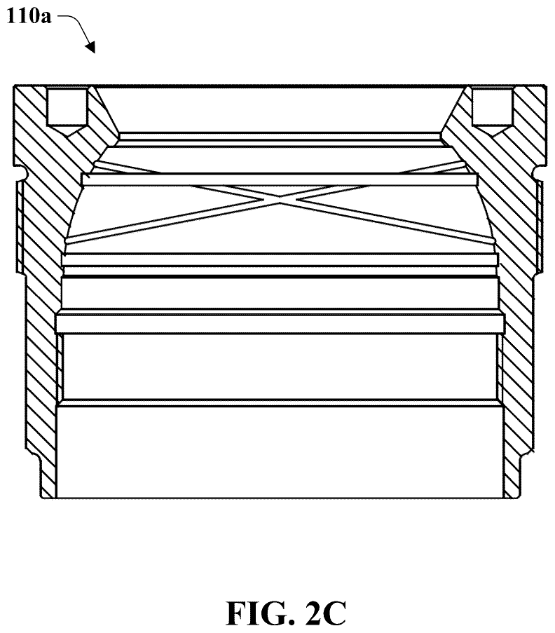

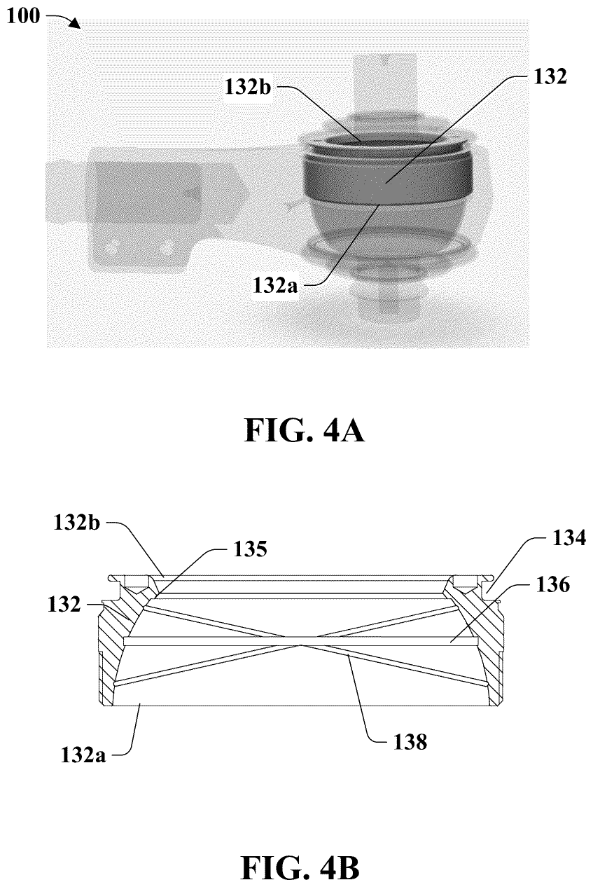

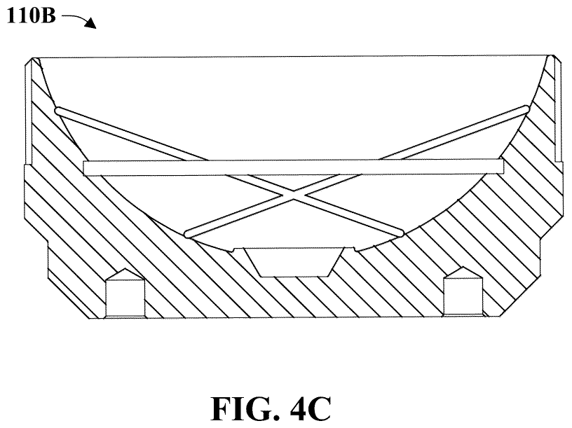

Turning now to FIGS. 2A and 2B, a housing 102 of a tie rod end is shown. The housing 102 can include a grease port 114 for receiving grease and allowing the grease to flow to an inside of the housing 102. The housing 102 can further include an inner cup 116 configured to receive the ball of the first ball stud 108. The inner cup 116 can have a concave shape. In certain embodiments, the concave inner cup 116 can be spherical or partially spherical in shape. Extending from a first end 116a of the inner cup 116 is a cap receptacle 118, which is configured to receive a cap (shown in FIG. 4A) to at least partially enclose the ball of the first ball stud 108 within the housing 102. In between and separating the cap receptacle 118 from the first end 116a of the inner cup 116 is a horizontal grease channel 120 that extends horizontally around a circumference of the first end 116a of the inner cup 116. The horizontal grease channel 120 can have a larger diameter than the inner diameter of the inner cup 116 at its first end 116a such that the horizontal grease channel 120 surrounds the ball of the first ball stud 108 while nested within the housing 102. The inner cup 116 can also include a seal receptacle 122 at a second end 116b opposite the first end 116a of the inner cup 116. In one embodiment, the seal receptacle 122 can include a groove in the outer diameter of the housing 102 around the second end 116b of the inner cup 116. The seal receptacle 122 is configured to receive the second end seal 106, for example, by way of an interference fit that includes a ridge on the second end seal 106 that fits into the groove. In this example, the inner diameter of the second end seal 106 is slightly smaller than the outer diameter of the groove in the seal receptacle 122. In certain embodiments, the second end seal 106 can have a seal clamp clamped over it to provide additional sealing pressure and to improve the coupling strength with the housing 102. In other embodiments, the seal receptacle 122 can receive the second end seal 106 by a threaded connection or a friction fit. The housing 102 can further include a shaft receptacle 124 configured to receive a shaft of the second ball stud 112. In certain embodiments, the shaft of the second ball stud 112 can screw into the shaft receptacle 124, or the shaft receptacle 124 can be tightened and/or clamped to the shaft of the second ball stud 112.

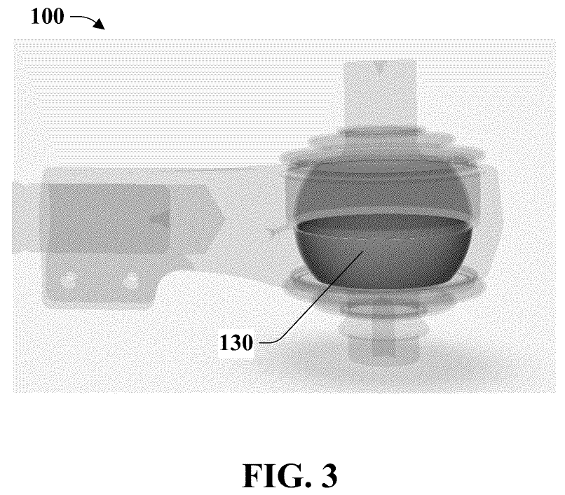

In certain embodiments, it may be advantageous to incorporate a liner 130 (shown in FIG. 3) into the inner cup 116 in order to provide a resilient surface to contact the ball of the first ball stud 108. The liner 130 may be, for example, constructed of a polymer. As shown in FIG. 2B, the inner cup 116 can include one or more grooves. When a liner 130 material such as a polymer material is injected and/or molded into the inner cup 116, the liner 130 material can enter and fill into the one or more grooves such that once the liner 130 material cures and becomes the liner 130, the liner 130 is incorporated into the one or more grooves and mechanically secured to the walls of the inner cup 116 thereby preventing the liner 130 from shifting, spinning, rocking, or rotating within the inner cup 116, even when a ball of the first ball stud 108 is moving within the inner cup 116. The one or more grooves can have a depth chosen using sound engineering judgment. In certain embodiments, the one or more grooves have a depth of less than 1 mm. In one embodiment, the one or more grooves have a depth of 0.75 mm. While the one or more grooves depicted in the figures are continuous grooves/channels, in certain embodiment, the one or more grooves can include other surface features such as knurls, bumps, ridges, protrusions, among others. The inner cup 116 can also include additional features for helping to mechanically secure the liner 130. Such additional features include an inner ridge 125 that extends around an inner diameter of the inner cup 116 proximate to the second end 116b. The liner 130 can engage with the inner ridge 125 to further secure the liner 130 within the inner cup 116.

In one embodiment, the one or more grooves in the inner cup 116 can include one or more horizontal grooves 126. The one or more horizontal grooves 126 can extend continuously around an entire inner circumference of the inner cup 116. In other embodiments, the one or more horizontal grooves 126 can be discontinuous around an entire inner circumference of the inner cup 116. When the liner 130 is incorporated into the one or more horizontal grooves 126, the one or more horizontal grooves 126 prevent the liner 130 from rocking within the inner cup 116.

In one embodiment, the one or more grooves in the inner cup 116 can further include one or more angled grooves 128. While the one or more horizontal grooves 126 can prevent a liner 130 from rocking within the inner cup 116, when the liner 130 is incorporated into the one or more angled grooves 128, the one or more angled grooves 128 can prevent the liner 130 from spinning within the inner cup 116 as well as providing further prevention of a rocking motion. In one embodiment, the one or more angled grooves 128 can be two grooves that form a crisscrossing pattern and intersect on opposite sides of the inner cup 116. For example, the crisscrossing pattern of the one or more angled grooves 128 can form one or more “figure-eight” patterns on the inner surface of the inner cup 116. It should be appreciated that the one or more angled grooves 128 can be oriented at any angle between zero degrees and ninety degrees from a horizontal axis, chosen using sound engineering judgment. In one embodiment, the one or more angled grooves 128 are oriented at a twenty-degree angle from a horizontal axis. The one or more angled grooves 128 can intersect with one another at one of the horizontal grooves 126, or they can intersect with one another offset from the one or more horizontal grooves 126. In certain embodiments, the one or more angled grooves 128 extend continuously around an entire inner circumference of the inner cup 116. In other embodiments, the one or more angled grooves 128 are discontinuous around an entire inner circumference of the inner cup 116.

It should be appreciated that the above description of features included on housing 102 can also similarly be included with respect to the housing 110a of the inner tie rod 110 as depicted in FIG. 2C.

FIG. 3 depicts the liner 130 covering at least a portion of the inner surface of the inner cup 116. The liner 130, once cured, can be mechanically secured to the inner surface of the inner cup 116 by the liner's 130 integration into the one or more grooves (e.g. the one or more horizontal grooves 126 and/or the one or more angled grooves 128). As a result, there exists a bearing surface between a ball of the first ball stud 108 and the liner 130 rather than a bearing surface existing between the liner 130 and the inner surface of the inner cup 116.

Turning now to FIG. 4A and FIG. 4B, a cap 132 is depicted. The cap 132 can have a concave shape and is configured to be coupled with and nest within the cap receptacle 118 within the housing 102. While the ball of the first ball stud 108 is nested within the inner cup 116, the cap 132 is configured to nest within the cap receptacle 118 to at least partially enclose the ball. While nested within the cap receptacle 118, a first end 132a of the cap 132 sits proximate to the first end 116a of the inner cup 116. In certain embodiments, the first end 132a of the cap 132 is separated from the first end 116a of the inner cup 116 by the horizontal grease channel 120. The cap 132 also includes a second end 132b opposite the first end 132a, the second end 132b having a seal receptacle 134 that is configured to receive the first end seal 104b. In one embodiment, the seal receptacle 134 can include a groove in the outer diameter of the cap 132. The seal receptacle 134 is configured to receive the first end seal 104, for example, by way of an interference fit that includes a ridge on the first end seal 104 that fits into the groove. In this example, the inner diameter of the first end seal 104 is slightly smaller than the outer diameter of the groove in the seal receptacle 134. In certain embodiments, the first end seal 104 can have a seal clamp clamped over it to provide additional sealing pressure and to improve the coupling strength with the cap 132. In other embodiments, the seal receptacle 134 can receive the first end seal 104 by a threaded connection or a friction fit.

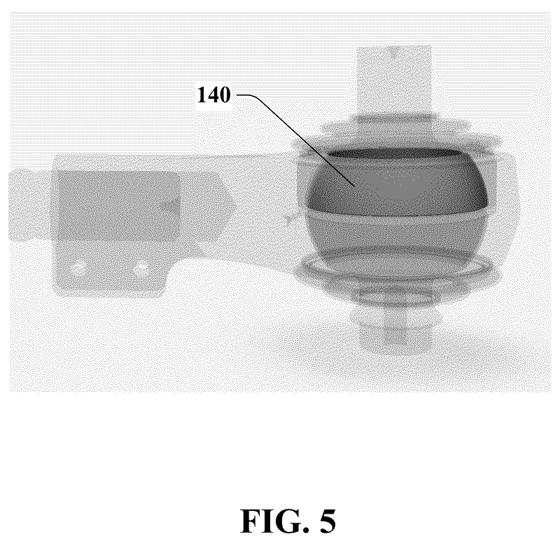

In certain embodiments, it may be advantageous to incorporate a cap liner 140 (shown in FIG. 5) into the inner surface of the cap 132 in order to provide a resilient surface to contact the ball of the first ball stud 108. The cap liner 140 may be, for example, constructed of a polymer. As shown in FIG. 4B, the cap 132 can include one or more grooves on its inner surface. When a cap liner 140 material such as a polymer material is injected and/or molded into the cap 132, the cap liner 140 material can enter and fill into the one or more grooves such that once the cap liner 140 material cures and becomes the cap liner 140, the cap liner 140 is incorporated into the one or more grooves and mechanically secured to the walls of the cap 132 thereby preventing the cap liner 140 from shifting, spinning, rocking, or rotating within the cap 132, even when a ball of the first ball stud 108 is moving within the cap 132. The one or more grooves can have a depth chosen using sound engineering judgment. In certain embodiments, the one or more grooves have a depth of less than 1 mm. In one embodiment, the one or more grooves have a depth of 0.75 mm. While the one or more grooves depicted in the figures are continuous grooves/channels, in certain embodiment, the one or more grooves can include other surface features such as knurls, bumps, ridges, protrusions, among others. The cap 132 can also include additional features for helping to mechanically secure the cap liner 140. Such additional features include an inner ridge 135 that extends around an inner diameter of the cap 132 proximate to the second end 132b. The cap liner 140 can engage with the inner ridge 135 to further secure the cap liner 140 within the cap 132.

In one embodiment, the one or more grooves in the cap 132 can include one or more horizontal cap grooves 136. The one or more horizontal cap grooves 136 can extend continuously around an entire inner circumference of the cap 132. In other embodiments, the one or more horizontal cap grooves 136 can be discontinuous around an entire inner circumference of the cap 132. When the cap liner 140 is incorporated into the one or more horizontal cap grooves 136, the one or more horizontal cap grooves 136 prevent the cap liner 140 from rocking within the cap 132.

In one embodiment, the one or more grooves in the cap 132 can further include one or more angled cap grooves 138. While the one or more horizontal cap grooves 136 can prevent a cap liner 140 from rocking within the cap 132, when the cap liner 140 is incorporated into the one or more angled cap grooves 138, the one or more angled cap grooves 138 can prevent the cap liner 140 from spinning within the cap 132 as well as providing further prevention of a rocking motion. In one embodiment, the one or more angled cap grooves 138 can be two grooves that form a crisscrossing pattern and intersect on opposite sides of the cap 132. For example, the crisscrossing pattern of the one or more angled cap grooves 138 can form one or more “figure-eight” patterns on the inner surface of the cap 132. It should be appreciated that the one or more angled cap grooves 138 can be oriented at any angle between zero degrees and ninety degrees from a horizontal axis, chosen using sound engineering judgment. In one embodiment, the one or more angled cap grooves 138 are oriented at a twenty-degree angle from a horizontal axis. The one or more angled cap grooves 138 can intersect with one another at one of the horizontal cap grooves 136, or they can intersect with one another offset from the one or more horizontal cap grooves 136. In certain embodiments, the one or more angled cap grooves 138 extend continuously around an entire inner circumference of the cap 132. In other embodiments, the one or more angled cap grooves 138 are discontinuous around an entire inner circumference of the cap 132.

It should be appreciated that the above description of features included on cap 132 can also similarly be included with respect to the cap 110b of the inner tie rod 110 as depicted in FIG. 4C.

FIG. 5 depicts the cap liner 140 covering at least a portion of the inner surface of the cap 132. The cap liner 140, once cured, can be mechanically secured to the inner surface of the cap 132 by the liner's 140 integration into the one or more grooves (e.g. the one or more horizontal cap grooves 136 and/or the one or more angled cap grooves 138). As a result, there exists a bearing surface between a ball of the first ball stud 108 and the cap liner 140 rather than a bearing surface existing between the cap liner 140 and the inner surface of the cap 132.

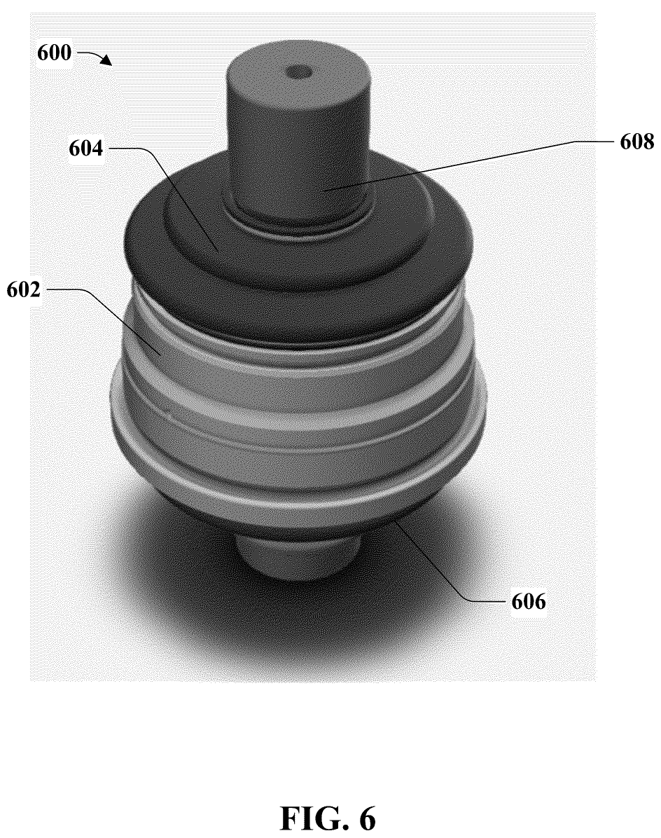

Turning now to FIG. 6, a ball joint 600 is shown. The ball joint 600 can include a housing 602. The housing 602 can be coupled at a first end to a first end seal 604 and at a second end to a second end seal 606. A ball stud 608 can include a ball (not shown in FIG. 6) nested within the housing 602, a first shaft extending from one end of the ball and through an aperture in the first end seal 604, and a second shaft extending from an opposite end of the ball and through an aperture in the second end seal 606. The ball stud 608 can undergo rotational movement and also a rocking movement in any direction with respect to the housing 602 while coupled with the housing 602. One exemplary application of the ball joint 600 is for use in the steering mechanism and/or suspension of a vehicle. The ball joint 600 can be incorporated into any vehicle, including, but not limited to, cars, trucks, all-terrain vehicles, construction equipment, tractors, combines, golf carts, among others.

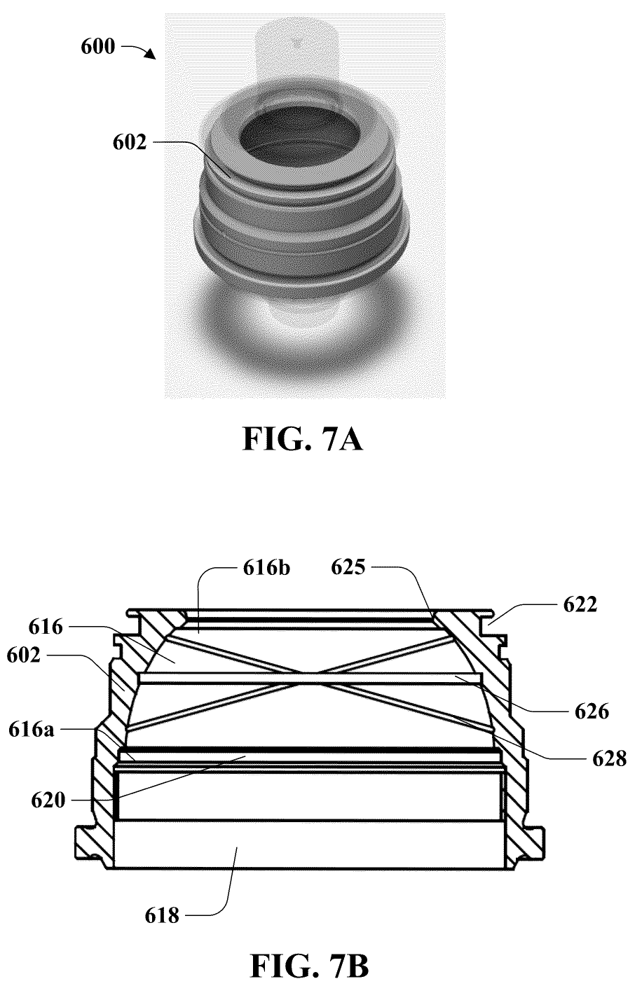

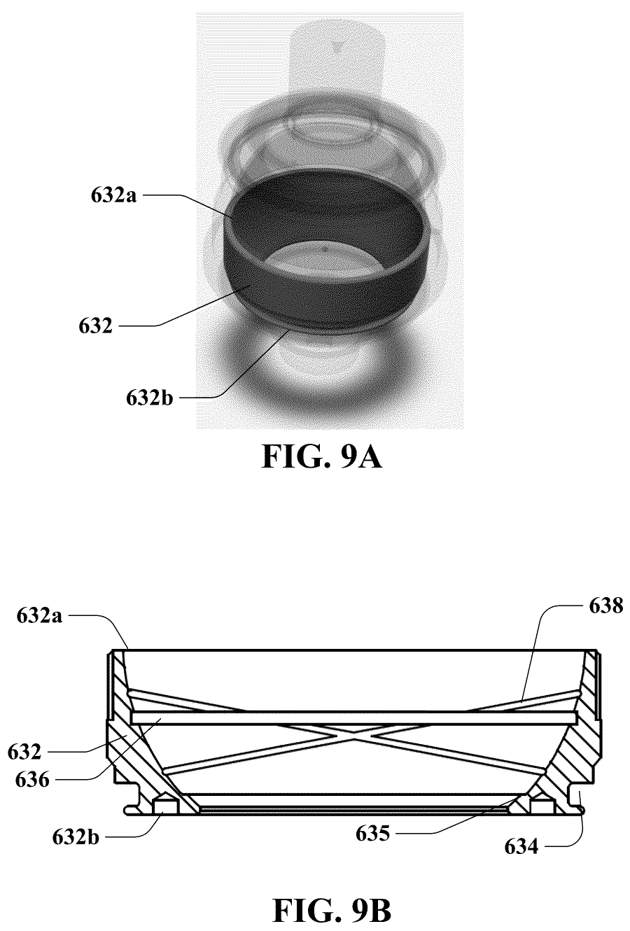

Turning now to FIGS. 7A and 7B, a housing 602 of a ball joint 600 is shown. The housing 602 can include an inner cup 616 configured to receive the ball of the ball stud 608. The inner cup 616 can have a concave shape. Extending from a first end 616a of the inner cup 616 is a cap receptacle 618, which is configured to receive a cap 632 (shown in FIG. 9A) to at least partially enclose the ball of the ball stud 608 within the housing 602. In between and separating the cap receptacle 618 from the first end 616a of the inner cup 616 is a horizontal grease channel 620 that extends horizontally around a circumference of the first end 616a of the inner cup 616. The horizontal grease channel 620 can have a larger diameter than the inner diameter of the inner cup 616 at its first end 616a such that the horizontal grease channel 620 surrounds the ball of the ball stud 608 while nested within the housing 602. The inner cup 616 can also include a seal receptacle 622 at a second end 616b opposite the first end 616a of the inner cup 116. In one embodiment, the seal receptacle 622 can include a groove in the outer diameter of the housing 602. The seal receptacle 622 is configured to receive the first end seal 604, for example, by way of an interference fit that includes a ridge on the first end seal 604 that fits into the groove. In this example, the inner diameter of the first end seal 604 is slightly smaller than the outer diameter of the groove in the seal receptacle 622. In certain embodiments, the first end seal 604 can have a seal clamp clamped over it to provide additional sealing pressure and to improve the coupling strength with the housing 602. In other embodiments, the seal receptacle 622 can receive the first end seal 604 by a threaded connection or a friction fit.

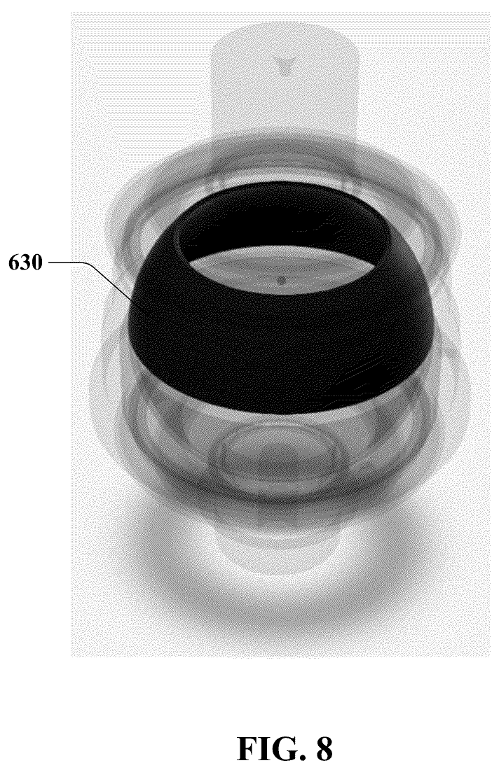

In certain embodiments, it may be advantageous to incorporate a liner 630 (shown in FIG. 8) into the inner cup 616 in order to provide a resilient surface to contact the ball of the ball stud 608. The liner 630 may be, for example, constructed of a polymer. As shown in FIG. 7B, the inner cup 616 can include one or more grooves. When a liner 630 material such as a polymer material is injected and/or molded into the inner cup 616, the liner 630 material can enter and fill into the one or more grooves such that once the liner 630 material cures and becomes the liner 630, the liner 630 is incorporated into the one or more grooves and mechanically secured to the walls of the inner cup 616 thereby preventing the liner 630 from shifting, spinning, rocking, or rotating within the inner cup 616, even when a ball of the ball stud 608 is moving within the inner cup 616. The one or more grooves can have a depth chosen using sound engineering judgment. In certain embodiments, the one or more grooves have a depth of less than 1 mm. In one embodiment, the one or more grooves have a depth of 0.75 mm. While the one or more grooves depicted in the figures are continuous grooves/channels, in certain embodiment, the one or more grooves can include other surface features such as knurls, bumps, ridges, protrusions, among others. The inner cup 616 can also include additional features for helping to mechanically secure the liner 630. Such additional features include an inner ridge 625 that extends around an inner diameter of the inner cup 616 proximate to the second end 616b. The liner 630 can engage with the inner ridge 625 to further secure the liner 630 within the inner cup 616.

In one embodiment, the one or more grooves in the inner cup 616 can include one or more horizontal grooves 626. The one or more horizontal grooves 626 can extend continuously around an entire inner circumference of the inner cup 616. In other embodiments, the one or more horizontal grooves 626 can be discontinuous around an entire inner circumference of the inner cup 616. When the liner 630 is incorporated into the one or more horizontal grooves 626, the one or more horizontal grooves 626 prevent the liner 630 from rocking within the inner cup 616.

In one embodiment, the one or more grooves in the inner cup 616 can further include one or more angled grooves 628. While the one or more horizontal grooves 626 can prevent a liner 630 from rocking within the inner cup 616, when the liner 630 is incorporated into the one or more angled grooves 628, the one or more angled grooves 628 can prevent the liner 630 from spinning within the inner cup 616 as well as providing further prevention of a rocking motion. In one embodiment, the one or more angled grooves 628 can be two grooves that form a crisscrossing pattern and intersect on opposite sides of the inner cup 616. For example, the crisscrossing pattern of the one or more angled grooves 628 can form one or more “figure-eight” patterns on the inner surface of the inner cup 616. It should be appreciated that the one or more angled grooves 628 can be oriented at any angle between zero degrees and ninety degrees from a horizontal axis, chosen using sound engineering judgment. In one embodiment, the one or more angled grooves 628 are oriented at a twenty-degree angle from a horizontal axis. The one or more angled grooves 628 can intersect with one another at one of the horizontal grooves 626, or they can intersect with one another offset from the one or more horizontal grooves 626. In certain embodiments, the one or more angled grooves 628 extend continuously around an entire inner circumference of the inner cup 616. In other embodiments, the one or more angled grooves 628 are discontinuous around an entire inner circumference of the inner cup 616.

FIG. 8 depicts the liner 630 covering at least a portion of the inner surface of the inner cup 616. The liner 630, once cured, can be mechanically secured to the inner surface of the inner cup 616 by the liner's 630 integration into the one or more grooves (e.g. the one or more horizontal grooves 626 and/or the one or more angled grooves 628). As a result, there exists a bearing surface between a ball of the ball stud 608 and the liner 630 rather than a bearing surface existing between the liner 630 and the inner surface of the inner cup 616.

Turning now to FIG. 9A and FIG. 9B, a cap 632 is depicted. The cap 632 can have a concave shape and is configured to couple to and nest within the cap receptacle 618 within the housing 602. While the ball of the ball stud 608 is nested within the inner cup 616, the cap 632 is configured to nest within the cap receptacle 618 to at least partially enclose the ball. While nested within the cap receptacle 618, a first end 632a of the cap 632 sits proximate to the first end 616a of the inner cup 616. In certain embodiments, the first end 632a of the cap 632 is separated from the first end 616a of the inner cup 616 by the horizontal grease channel 620. The cap 632 also includes a second end 632b opposite the first end 632a, the second end 632b having a seal receptacle 634 that is configured to receive the second end seal 606. In one embodiment, the seal receptacle 634 can include a groove in the outer diameter of the cap 632. The seal receptacle 634 is configured to receive the second end seal 606, for example, by way of an interference fit that includes a ridge on the second end seal 606 that fits into the groove. In this example, the inner diameter of the second end seal 606 is slightly smaller than the outer diameter of the groove in the seal receptacle 634. In certain embodiments, the second end seal 606 can have a seal clamp clamped over it to provide additional sealing pressure and to improve the coupling strength with the cap 632. In other embodiments, the seal receptacle 634 can receive the second end seal 606 by a threaded connection or a friction fit.

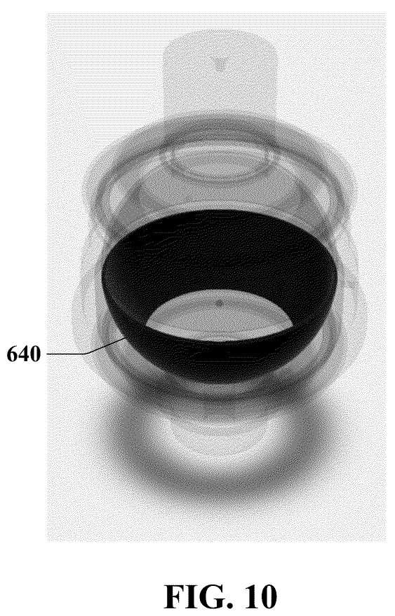

In certain embodiments, it may be advantageous to incorporate a cap liner 640 (shown in FIG. 10) into the inner surface of the cap 632 in order to provide a resilient surface to contact the ball of the ball stud 608. The cap liner 640 may be, for example, constructed of a polymer. As shown in FIG. 9B, the cap 632 can include one or more grooves on its inner surface. When a cap liner 640 material such as a polymer material is injected and/or molded into the cap 632, the cap liner 640 material can enter and fill into the one or more grooves such that once the cap liner 640 material cures and becomes the cap liner 640, the cap liner 640 is incorporated into the one or more grooves and mechanically secured to the walls of the cap 632 thereby preventing the cap liner 640 from shifting, spinning, rocking, or rotating within the cap 632, even when a ball of the first ball stud 608 is moving within the cap 632. The one or more grooves can have a depth chosen using sound engineering judgment. In certain embodiments, the one or more grooves have a depth of less than 1 mm. In one embodiment, the one or more grooves have a depth of 0.75 mm. While the one or more grooves depicted in the figures are continuous grooves/channels, in certain embodiment, the one or more grooves can include other surface features such as knurls, bumps, ridges, protrusions, among others. The cap 632 can also include additional features for helping to mechanically secure the cap liner 640. Such additional features include an inner ridge 635 that extends around an inner diameter of the cap 632 proximate to the second end 632b. The cap liner 640 can engage with the inner ridge 635 to further secure the cap liner 640 within the cap 632.

In one embodiment, the one or more grooves in the cap 632 can include one or more horizontal cap grooves 636. The one or more horizontal cap grooves 636 can extend continuously around an entire inner circumference of the cap 632. In other embodiments, the one or more horizontal cap grooves 636 can be discontinuous around an entire inner circumference of the cap 632. When the cap liner 640 is incorporated into the one or more horizontal cap grooves 636, the one or more horizontal cap grooves 636 prevent the cap liner 640 from rocking within the cap 632.

In one embodiment, the one or more grooves in the cap 640 can further include one or more angled cap grooves 638. While the one or more horizontal cap grooves 636 can prevent a cap liner 640 from rocking within the cap 632, when the cap liner 640 is incorporated into the one or more angled cap grooves 638, the one or more angled cap grooves 638 can prevent the cap liner 640 from spinning within the cap 632 as well as providing further prevention of a rocking motion. In one embodiment, the one or more angled cap grooves 638 can be two grooves that form a crisscrossing pattern and intersect on opposite sides of the cap 632. For example, the crisscrossing pattern of the one or more angled cap grooves 638 can form one or more “figure-eight” patterns on the inner surface of the cap 632. It should be appreciated that the one or more angled cap grooves 638 can be oriented at any angle between zero degrees and ninety degrees from a horizontal axis, chosen using sound engineering judgment. In one embodiment, the one or more angled cap grooves 638 are oriented at a twenty-degree angle from a horizontal axis. The one or more angled cap grooves 638 can intersect with one another at one of the horizontal cap grooves 636, or they can intersect with one another offset from the one or more horizontal cap grooves 636. In certain embodiments, the one or more angled cap grooves 638 extend continuously around an entire inner circumference of the cap 632. In other embodiments, the one or more angled cap grooves 638 are discontinuous around an entire inner circumference of the cap 632.

FIG. 10 depicts the cap liner 640 covering at least a portion of the inner surface of the cap 632. The cap liner 640, once cured, can be mechanically secured to the inner surface of the cap 632 by the liner's 640 integration into the one or more grooves (e.g. the one or more horizontal cap grooves 636 and/or the one or more angled cap grooves 638). As a result, there exists a bearing surface between a ball of the ball stud 608 and the cap liner 640 rather than a bearing surface existing between the cap liner 640 and the inner surface of the cap 632.

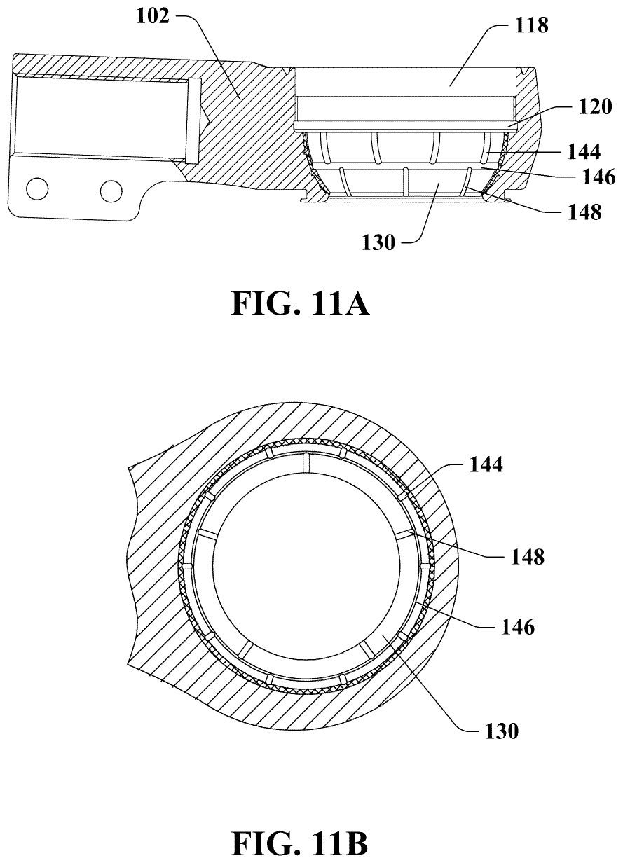

Turning now to FIGS. 11A and 11B, an exemplary housing 102 for a tie rod 100 is shown having an exemplary liner 130 within the inner cup 116. In certain embodiments, the liner 130 can be made of a polymer material. The thickness of the liner 130 can be chosen using sound engineering judgment. In one embodiment, the liner 130 has a thickness of 2 mm. The liner 130 can have one or more grease grooves in its inner surface, the one or more grease grooves being configured to provide passageways for grease to flow from within the inner cup 116 to a first grease vent in the second end seal 106 coupled to the second end 116b of the inner cup 116 by way of, for example, the seal receptacle 122. The one or more grease grooves can include, for example, a first set of vertical grease grooves 144, a horizontal groove 146, and a second set of vertical grease grooves 148. The first set of vertical grease grooves 144, the horizontal grease groove 146, and the second set of vertical grease grooves 148 can each be connected as to provide a continuous flow path from the horizontal grease channel 120 to the first grease vent in the second end seal 106. The horizontal grease channel 120 can be a gap between the cap 132 and the inner cup 116 that provides a void for grease to collect along an entire perimeter between the inner cup 116 and a ball of the first ball stud 108. The grease can flow from the horizontal grease channel 120 through the first set of vertical grease grooves 144, the horizontal groove 146, and/or the second set of vertical grease grooves 148. When the pressure of the grease increases to a pre-determined pressure, the grease can exit through the first grease vent of the second end seal 106 by, for example, forcing its way past a lip of the first grease vent of the second end seal 106. This process allows a purge of excess grease via the first grease vent of the second end seal 106 while maintaining a seal around the first ball stud 108.

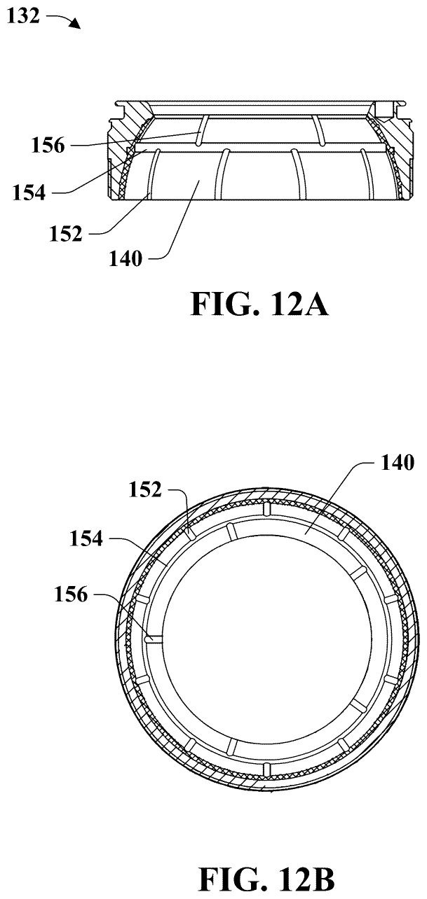

Turning now to FIGS. 12A and 12B, an exemplary cap 132 is shown having an exemplary cap liner 140 within the cap 132. In certain embodiments, the cap liner 140 can be made of a polymer material. The thickness of the cap liner 140 can be chosen using sound engineering judgment. In one embodiment, the cap liner 140 has a thickness of 2 mm. The cap liner 140 can have one or more cap grease grooves in its inner surface, the one or more cap grease grooves being configured to provide passageways for grease to flow from within the cap 132 to a second grease vent in the first end seal 104 coupled to the second end 132b of the cap 132 by way of, for example, the seal receptacle. The one or more grease grooves can include, for example, a first set of vertical cap grease grooves 152, a horizontal cap grease groove 154, and a second set of vertical cap grease grooves 156. The first set of vertical cap grease grooves 152, the horizontal cap grease groove 154, and the second set of vertical cap grease grooves 156 can each be connected as to provide a continuous flow path from the horizontal grease channel 120 to the second grease vent in the first end seal 104 while the cap 132 is secured to the tie rod housing 102. As discussed above, the horizontal grease channel 120 can be a gap between the cap 132 and the inner cup 116 that provides a void for grease to collect along an entire perimeter between the inner cup 116 and a ball of the first ball stud 108. The grease can flow from the horizontal grease channel 120 through the first set of vertical cap grease grooves 152, the horizontal cap grease groove 154, and/or the second set of vertical cap grease grooves 156. When the pressure of the grease increases to a pre-determined pressure, the grease can exit through the second grease vent of the first end seal 104 by, for example, forcing its way past a lip of the second grease vent of the first end seal 104. This process allows a purge of excess grease via the second grease vent of the first end seal 104 while maintaining a seal around the first ball stud 108. It should be appreciated that the one or more grease grooves in the inner cup's liner 130 and the one or more cap grease grooves in the cap's liner 140 can operate to provide grease purging functionality simultaneously via the first grease vent of the second end seal 106 and the second grease vent of the first end seal 104, respectively.

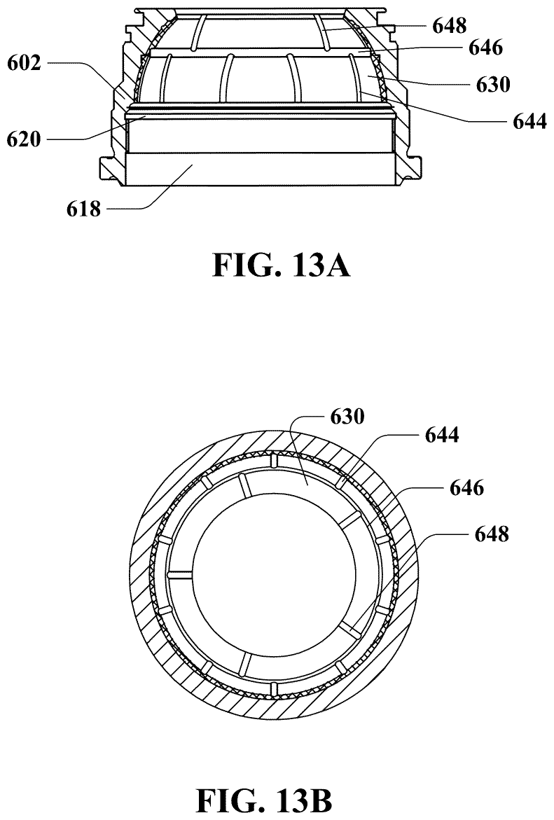

Turning now to FIGS. 13A and 13B, an exemplary housing 602 for a ball joint 600 is shown having an exemplary liner 630 within the inner cup 616. In certain embodiments, the liner 630 can be made of a polymer material. The thickness of the liner 630 can be chosen using sound engineering judgment. In one embodiment, the liner 630 has a thickness of 2 mm. The liner 630 can have one or more grease grooves in its inner surface, the one or more grease grooves being configured to provide passageways for grease to flow from within the inner cup 616 to a first grease vent in the first end seal 604 coupled to the second end 616b of the inner cup 616 by way of, for example, the seal receptacle 622. The one or more grease grooves can include, for example, a first set of vertical grease grooves 644, a horizontal grease groove 646, and a second set of vertical grease grooves 648. The first set of vertical grease grooves 644, the horizontal grease groove 646, and the second set of vertical grease grooves 648 can each be connected as to provide a continuous flow path from the horizontal grease channel 620 to the first grease vent in the first end seal 604. The horizontal grease channel 620 can be a gap between the cap 632 and the inner cup 616 that provides a void for grease to collect along an entire perimeter between the inner cup 616 and a ball of the ball stud 608. The grease can flow from the horizontal grease channel 620 through the first set of vertical grease grooves 644, the horizontal grease groove 646, and/or the second set of vertical grease grooves 648. When the pressure of the grease increases to a pre-determined pressure, the grease can exit through the first grease vent of the first end seal 604 by, for example, forcing its way past a lip of the first grease vent of the first end seal 604. This process allows a purge of excess grease via the first grease vent of the first end seal 604 while maintaining a seal around the ball stud 608.

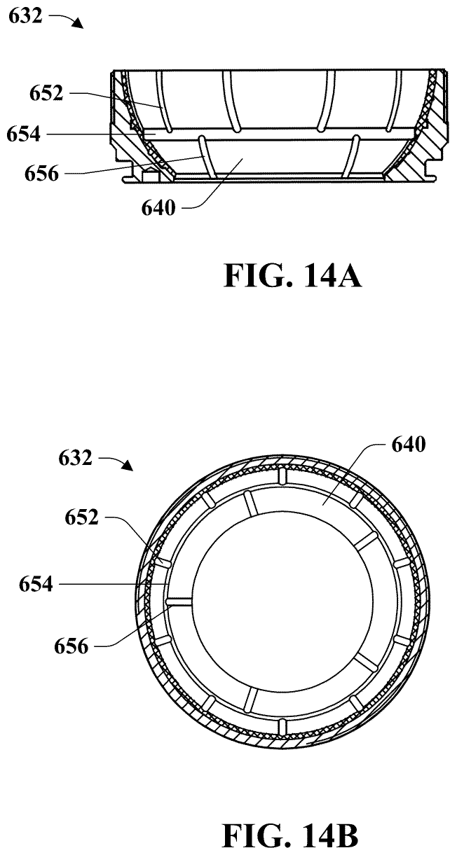

Turning now to FIGS. 14A and 14B, an exemplary cap 632 is shown having an exemplary cap liner 640 within the cap 632. In certain embodiments, the cap liner 640 can be made of a polymer material. The thickness of the cap liner 640 can be chosen using sound engineering judgment. In one embodiment, the cap liner 640 has a thickness of 2 mm. The cap liner 640 can have one or more cap grease grooves in its inner surface, the one or more cap grease grooves being configured to provide passageways for grease to flow from within the cap 632 to a second grease vent in the second end seal 606 coupled to the second end 632b of the cap 632 by way of, for example, the seal receptacle 634. The one or more cap grease grooves can include, for example, a first set of vertical cap grease grooves 652, a horizontal cap grease groove 654, and a second set of vertical cap grease grooves 656. The first set of vertical cap grease grooves 652, the horizontal cap grease groove 654, and the second set of vertical cap grease grooves 656 can each be connected as to provide a continuous flow path from the horizontal grease channel 620 to the second grease vent in the second end seal 606 while the cap 632 is secured to the ball joint housing 602. As discussed above, the horizontal grease channel 620 can be a gap between the cap 632 and the inner cup 616 that provides a void for grease to collect along an entire perimeter between the inner cup 616 and a ball of the ball stud 608. The grease can flow from the horizontal grease channel 620 through the first set of vertical cap grease grooves 652, the horizontal cap grease groove 654, and/or the second set of vertical cap grease grooves 656. When the pressure of the grease increases to a pre-determined pressure, the grease can exit through the second grease vent of the second end seal 606 by, for example, forcing its way past a lip of the second grease vent of the second end seal 606. This process allows a purge of excess grease via the second grease vent 650 while maintaining a seal around the ball stud 608. It should be appreciated that the one or more grease grooves in the inner cup's liner 630 and the one or more cap grease grooves in the cap's liner 640 can operate to provide grease purging functionality simultaneously via the first grease vent in the first end seal 604 and the second grease vent in the second end seal 606, respectively.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A joint assembly comprising:
a housing having a concave inner cup, wherein the concave inner cup includes an inner surface having one or more angled grooves extending around at least a portion of a circumference of the inner surface; and
a liner molded into the inner cup, wherein the liner fills the one or more angled grooves such that the liner is mechanically secured to the inner surface of the inner cup.

2. The joint assembly of claim 1, wherein the inner surface of the inner cup further includes a horizontal groove, and the liner fills the horizontal groove.

3. The joint assembly of claim 2, wherein the horizontal groove extends around an inner circumference of the inner cup.

4. The joint assembly of claim 1, wherein the one or more angled grooves are two grooves that form a crisscrossing pattern.

5. The joint assembly of claim 4, wherein the two grooves intersect on opposite sides of the inner cup.

6. The joint assembly of claim 1, wherein the one or more angled grooves are oriented at an angle between zero degrees and ninety degrees from a horizontal axis.

7. The joint assembly of claim 1, wherein the liner is constructed of a polymer.

8. The joint assembly of claim 1, further comprising:
a cap that has a concave shape and is configured to be coupled with and nest within a cap receptacle within the housing, wherein the cap includes a cap inner surface having one or more angled cap grooves extending around at least a portion of a circumference of the cap inner surface; and
a cap liner molded into the cap, wherein the cap liner fills the one or more angled cap grooves such that the cap liner is mechanically secured to the cap inner surface.

9. The joint assembly of claim 8, wherein the cap inner surface further includes a horizontal cap groove, and the cap liner fills the horizontal cap groove.

10. The joint assembly of claim 9, wherein the horizontal cap groove extends around an inner circumference of the cap.

11. The joint assembly of claim 8, wherein the one or more angled cap grooves are two cap grooves that form a crisscrossing pattern.

12. The joint assembly of claim 11, wherein the two cap grooves intersect on opposite sides of the cap.

13. The joint assembly of claim 8, wherein the one or more angled cap grooves are oriented at an angle between zero degrees and ninety degrees from a horizontal axis.

14. The joint assembly of claim 8, wherein the cap liner is constructed of a polymer.

15. The joint assembly of claim 8, further comprising:
a ball nested within the inner cup, and
wherein the cap is configured to nest within the cap receptacle to at least partially enclose the ball.

16. The joint assembly of claim 15, wherein a bearing surface exists between the ball and the liner.

17. The joint assembly of claim 1, wherein the joint assembly is part of a tie rod.

18. The joint assembly of claim 1, wherein the joint assembly is part of a ball joint.

19. A method of manufacturing a joint assembly, comprising:
providing a housing having a concave inner cup, wherein the concave inner cup includes an inner surface having one or more grooves extending around at least a portion of a circumference of the inner surface;
injecting or molding a liner material into the inner cup such that the liner material enters and fills into the one or more grooves; and
curing the liner material to form a liner that is incorporated into the one or more grooves and mechanically secured to the inner cup.

20. The method of claim 19, further comprising:
providing a cap that has a concave shape, wherein the cap includes a cap inner surface having one or more cap grooves extending around at least a portion of a circumference of the cap inner surface
injecting or molding a cap liner material into the cap such that the cap liner material enters and fills into the one or more cap grooves; and
curing the cap liner material to form a cap liner that is incorporated into the one or more cap grooves and mechanically secured to walls of the cap.
